(19) United States
(12) Patent Application Publication
(10) Pub. No.: US 2009/0295010 A1
(43) Pub. Date: Dec. 3, 2009

(54) DIRECT APPLICATION OF SURFACE TREATMENT TO A MOLTEN PARISON

(75) Inventors: KEVIN D. HIMES, MOUNT WOLF, PA (US); LAWRENCE KORPANTY, YORK, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: GRAHAM PACKAGING COMPANY, L.P., YORK, PA (US)

(21) Appl. No.: 12/131,297

(22) Filed: Jun. 2, 2008

(51) Int. Cl. B29C 35/08

(52) U.S. Cl. 264/80; 425/113

(57) ABSTRACT

A system for forming a molded object out of a plastic material includes an extrusion die assembly for forming a molten parison, a molding assembly for molding the molten parison into a molded article and a surface treatment assembly for changing the surface energy of at least a portion of a molten parison while the parison is in a molten state. The surface treatment assembly is interposed between the extrusion die assembly and the molding assembly to permit a surface energy of the parison to be changed prior to molding. This facilitates printing on the molded article while the molded article is still in the mold assembly. A method of making a molded object out of a plastic material is also disclosed.

### BACKGROUND OF THE INVENTION

1. Field of the Invention

This invention relates generally to the field of manufacturing plastic articles such as containers, and more specifically to the manufacturer of such articles using the extrusion blow molding process.

2. Description of the Related Technology

Plastic containers for various products are commonly manufactured using the extrusion blow molding process, in which the container is formed from a continuously extruded molten tube known as a parison that is periodically captured and inflated within a moving mold assembly, which can be a wheel mold, a shuttle type mold or any one of a number of alternative designs that are known in the industry. The extruded parison typically includes several layers of plastic material, with polyolefin being the most common type of plastic material that is employed.

Most plastic containers that are intended for consumer use require some type of printing or decoration to be applied to the exterior of the container. Unfortunately, plastic material such as polyolefin typically exhibits a low surface energy and resultant poor wettability that makes it difficult to effectively print on the exterior of the container. More specifically, because of the poor wettability and low surface energy of the plastic material, adhesives, paints, inks, and other coatings tend not to adhere well to the outer surface of the plastic container.

In order to address this problem, plastic containers are commonly surface treated to improve their wettability and to increase their surface tension after they have been ejected from the mold, but before printing. The most common types of such surface treatment that are currently in commercial use are flame treatment, corona treatment and plasma treatment. Flame treatment involves exposing the molded container to an open flame so as to increase the surface energy of the treated surface. Corona discharge treatment process involves exposing the surface to be treated to a corona discharge. Plasma treatment involves exposing the surface to be treated to a plasma discharge, sometimes but not necessarily in near vacuum conditions. The details of these processes are well known to those having ordinary skill in this area of technology.

Various methods have been proposed to permit application of surface decoration to a container while the container is still in the forming mold. Some types of in mold labeling, wherein a preprinted label is applied to the external surface of the container while the container is still in the mold, are in commercial use. Other methods for applying an ink based decoration directly to the surface of the container while the container is still in the mold have been proposed, but have not been successfully commercially deployed. One of the reasons for this is that the surface tension characteristics of the exterior surface of the container at the point in time that it is being formed in the mold are not acceptable for receiving ink, die or paint.

It has been proposed in U.S. Published Patent Application US/2007/0057411 A1 to enhance the surface tension characteristics of a raw plastic material prior to extrusion by plasma treating the granular raw plastic material. However, such a process would not permit the selective application of surface treatment to a limited portion of a container, such as an outer portion of the surface without treating the inner surface or a limited portion of the container. In addition, because the surface energy of plastic material that is processed using plasma treatment will tend to decrease over time, it would be difficult to exercise quality control over the actual surface tension of the extruded parison and extrusion blow molding facility without carefully monitoring the amount of time that has elapsed between the date of treatment of the raw granular material in the date of use of that material at the extrusion blow molding facility.

A need exists for a system and process of effectively controlling the surface energy of an external surface of a parison in an extrusion blow molding process that permits application of surface treatment to selected portions of the parison prior to molding, such as an outer portion of the surface without treating the inner surface, and that facilitates close control of the surface energy of the molded object as it is being molded.

### SUMMARY OF THE INVENTION

Accordingly, it is an object of the invention to provide a system and process of effectively controlling the surface energy of an external surface of a parison in an extrusion blow molding process that permits application of surface treatment to selected portions of the parison prior to molding, such as an outer portion of the surface without treating the inner surface, and that facilitates close control of the surface energy of the molded object as it is being molded.

In order to achieve the above and other objects of the invention, a system for forming a molded object out of a plastic material according to a first aspect of the invention may include an extrusion die assembly for forming an extruded plastic parison; a mold assembly for forming a portion of the extruded plastic parison into a molded article; and a surface treatment assembly for changing the surface energy of at least a portion of the extruded plastic parison, the surface treatment assembly being interposed between the extrusion die assembly and the mold assembly.

According to a second aspect of the invention, a system for forming a molded object out of a plastic material may include a surface treatment assembly for changing the surface energy of at least a portion of a molten plastic object while the plastic object is in a molten state; and a mold assembly for forming a portion of the molten plastic object into a molded article.

According to a third aspect of the invention, a method of forming a molded object out of a plastic material may include steps of providing a molten plastic object; changing the surface energy of at least a portion of the molten plastic object while it is in a molten state; and molding at least a portion of the molten plastic object into a molded article.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a schematic depiction of a system for making a decorated plastic article according to a preferred embodiment of the invention;

FIG. 2 is another schematic depiction of a system for making a decorated plastic article according to a preferred embodiment of the invention;

FIG. 3 is a schematic depiction of an alternative preferred embodiment of a system for making a decorated plastic article;

FIG. 4 is a schematic depiction of another alternative preferred embodiment of a system for making a decorated plastic article;

FIG. 5 is a schematic depiction of a mold assembly according to one preferred embodiment;

FIG. 6 is a schematic depiction of a mold assembly according to another preferred embodiment;

FIG. 7 is a schematic depiction of a mold assembly according to yet another preferred embodiment;

FIG. 8 is a schematic depiction of a mold assembly according to yet another preferred embodiment; and

FIG. 9 is a flow chart depicting a method according to a preferred embodiment of the invention.

### DETAILED DESCRIPTION OF THE PREFERRED EMBODIMENT(S)

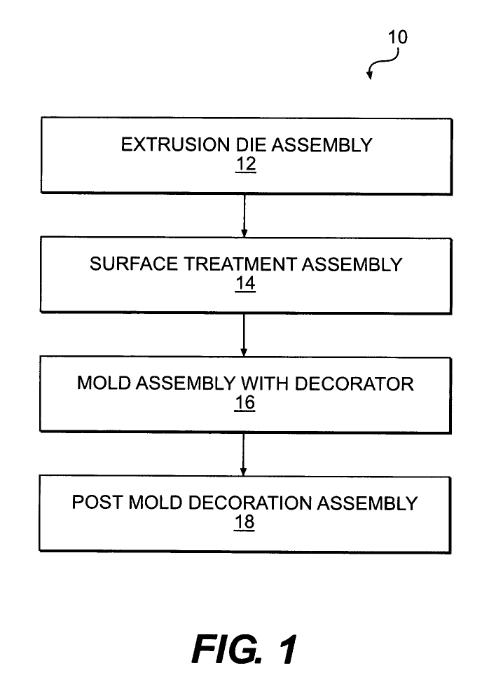

Referring now to the drawings, wherein like reference numerals designate corresponding structure throughout the views, and referring in particular to FIG. 1, a system 10 for making a decorated plastic article according to a preferred embodiment of the invention includes an extrusion die assembly 12 for forming an extruded plastic parison, a surface treatment assembly 14 for changing the surface energy of at least a portion of the extruded plastic parison and a mold assembly 16 for forming a portion of the extruded plastic parison into a molded article, which is preferably a container.

In addition, system 10 preferably includes a post mold decoration assembly 18 for printing an additional decoration on the molded article after the molded article has been removed from the mold assembly 16.

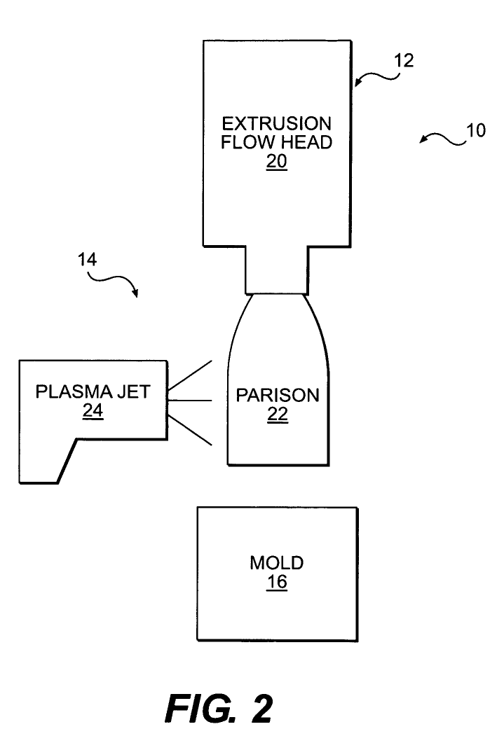

The extrusion die assembly 12, which is schematically shown in greater detail in FIG. 2, is preferably of conventional construction, and is constructed and arranged to heat a plastic material such as polyolefin into a molten state and to extrude the molten plastic material from an extrusion flow head 20 into a molten parison 22. As is well known in the industry, the extrusion die assembly 12 may be although is not necessarily configured to extrude a molten parison 22 that includes two or more concentrically formed layers of molten plastic, adhesive, barrier material and other materials that are well known in this area of technology.

The surface treatment assembly 14 is preferably interposed between the extrusion die assembly 12 and the mold assembly 16 so that surface treatment may be applied to the molten parison 22 after it leaves the extrusion die assembly 12 but before it is contacted by the mold assembly 16.

The mold assembly 16 may be embodied in a wheel configuration, a shuttle configuration or any one of a number of alternative configurations, all of which are well known to those having ordinary skill in this area of technology.

Preferably, the surface treatment assembly 14, or the surface treatment assembly 28, 34 that is discussed below with respect alternative embodiments is constructed and arranged to increase the surface energy of at least a portion of the extruded plastic parison 22. Preferably, the surface treatment assembly 14, 28, 34 is constructed and arranged to change the surface energy of a selected portion of the extruded plastic parison 22 that is less than the entire outer surface of the parison 22.

In addition, the system for making a decorated plastic article preferably is constructed and arranged to ensure registration of the selected portion of the extruded plastic parison 22 with a select portion of the mold assembly 16. This permits selective treatment of the portions of the extruded plastic parison 22 that correspond to portions of the molded article on which a decoration is to be printed.

In one embodiment, such selective treatment is applied to a limited depth of the molten parison so that the outer surface or a portion of the outer surface of the molten parison is treated without treating the inner surface of the molten parison. In other words, the outer surface of the extruded plastic parison is treated to a greater extent than the inner surface of the extruded plastic parison is treated. During and after the molding process, this will result in a molded container or other object that has an outer surface or a portion of the outer surface that has been treated, but an untreated inner surface. This may be beneficial for many products, as it will preserve certain properties of the inner surface that are useful for containers that are intended to be used to package many substances. These may be barrier properties, or properties that make it easier for a consumer to effectively evacuate product from the container.

The surface treatment is preferably affected so as to cause the treated portions of the extruded plastic parison 22 to have a surface energy that is within a range of about 38 dynes to about 70 dynes.

In addition, it is known that stretching of molten plastic material within a mold has the tendency to reduce the surface energy of the plastic material. Accordingly, the ability of the surface treatment assembly to selectively treat portions of the extruded plastic parison 22 will permit those portions that are expected to be stretched to a greater extent during molding to be surface treated to preferentially increase the surface energy of those portions more than portions of the extruded plastic parison 22 that are not expected to be so stretched. The selective treatment may be modulated not only in the selection of the specific areas to be treated, but also in the degree of treatment that is to be applied.

In the embodiment of the invention that is schematically depicted in FIG. 2, the surface treatment assembly 14 is embodied as a plasma treatment system 24 for applying a plasma treatment to at least a portion of the molten plastic parison 22. The details of such a plasma treatment system 24 are well known in this area of technology. Such a system may be commercially obtained from Corotec Corporation of Farmington, Conn., and is constructed and arranged to treat the selected portion of the molten parison 22 with a plasma discharge. This could be but is not preferably performed in near vacuum conditions.

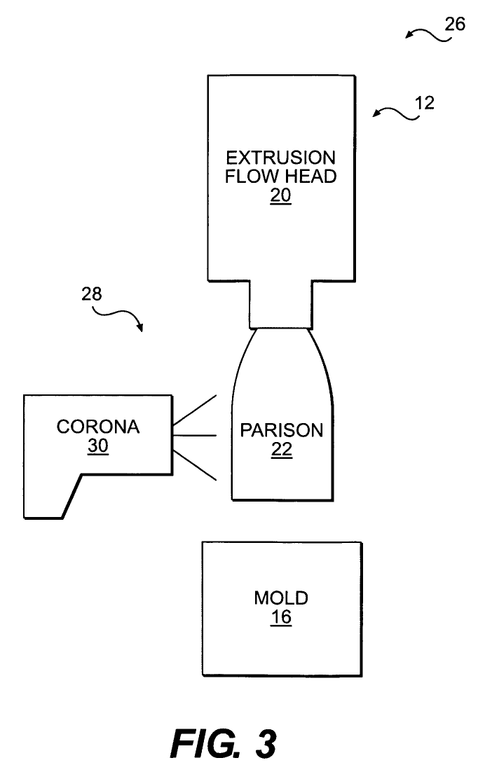

In the embodiment of the invention that is schematically depicted in FIG. 3, a system 26 for making a decorated plastic article includes a surface treatment assembly 26 that is embodied as a corona discharge system 30 for applying a corona discharge treatment to at least a portion of the molten plastic parison 22. The details of such a corona discharge treatment system are well known in this area of technology. Such a system may be commercially obtained from Corotec Corporation of Farmington, Conn., and is constructed and arranged to treat the selected portion of the molten parison 22 with a corona discharge.

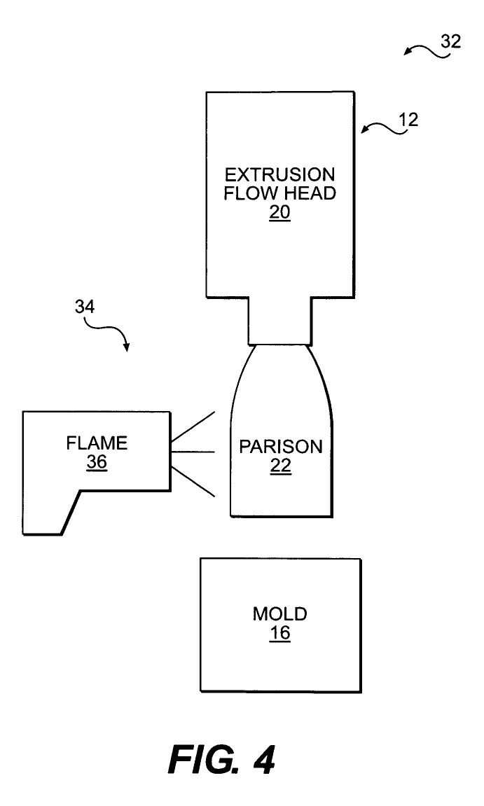

In the embodiment of the invention that is schematically depicted in FIG. 4, a system 32 for making a decorated plastic article includes a surface treatment assembly 34 that is embodied as a flame treatment system 36 for applying a flame treatment to at least a portion of the molten plastic parison 22. The details of such a flame treatment system are well known in this area of technology. Such a system may be commercially obtained from FTS Technologies of Whitmore Lake, Mich., and is constructed and arranged to treat the selected portion of the molten parison 22 with a hot flame.

One advantage of the positioning of the surface treatment assembly 14 prior to the mold assembly 16 is that it facilitates the printing of a decoration on a molded article while the molded article is still within the mold assembly 16. For purposes of this document, the term decoration shall be construed as being inclusive of various printed patterns that may be applied to a molded article such as a container, including informative patterns such as writing as well as patterns that are strictly ornamental in nature.

To that end, mold assembly 16 preferably is constructed and arranged to facilitate the printing of a decoration on the molded article while the molded article is still within the mold assembly 16.

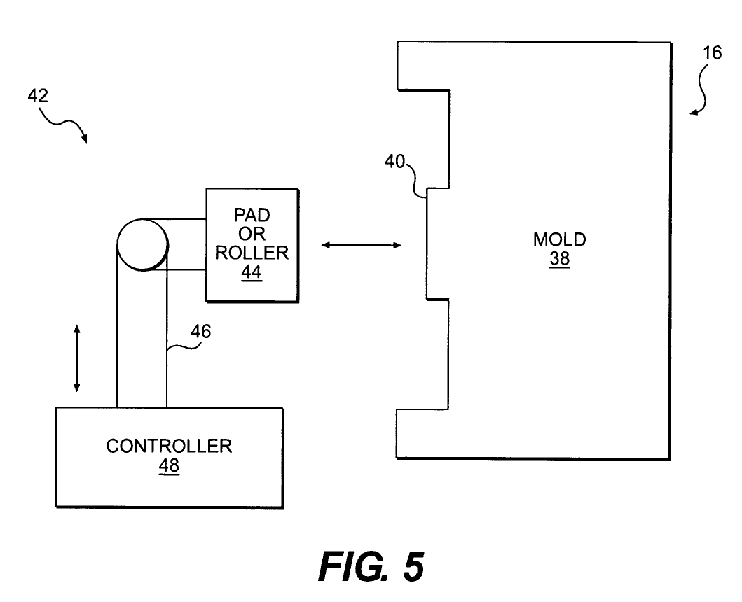

In the embodiment that is depicted schematically in FIG. 5, the mold assembly 16 includes a mold 38 that has an internal surface for forming an external surface of a molded article out of the molten plastic parison 22. Typically in the extrusion blow molding process the molten plastic parison 22 is captured by the mold assembly 16 and is inflated using compressed air or an alternative pressurized gas so that the exterior surfaces of the plastic parison 22 conform to the internal surface of the mold 38, including a mold surface portion 40 that corresponds to a portion of the molded article to which a decoration is intended to be applied.

While the mold surface portion 40 is schematically depicted in FIG. 5 as being flat, it is to be understood that it can be formed in any one of the multiplicity of different possible shapes. One of the advantages of printing a decoration within the mold assembly 16 is that it permits printing of a decoration on portions of the molded article that are otherwise difficult to decorate using a postmold decorating process. For example, recessed portions and complex curvatures of a molded article tend to be difficult to decorate using a postmold operation.

In the embodiment of FIG. 5 an ink transfer system 42 is provided that includes an applicator 44 for applying an ink decoration to the selected mold surface portion 40 prior to molding. For purposes of this document, an ink decoration shall be construed to mean a decoration that is applied as an ink or dye to an external surface of a molded container, as opposed to a decoration that is applied using an adhesive substrate such as a label.

The applicator 44 may be embodied as a pad or a roller that is placed in contact with the selected mold surface portion 40 in order to transfer the ink or dye to the selected mold surface portion 40 prior to molding. Ink transfer system 42 further preferably includes a drive mechanism 46 and a controller 48, which is preferably programmable. The ink or dye pattern that is applied to the mold surface portion 40 will then be transferred to the corresponding portion of the external surface of the molded article during the molding process.

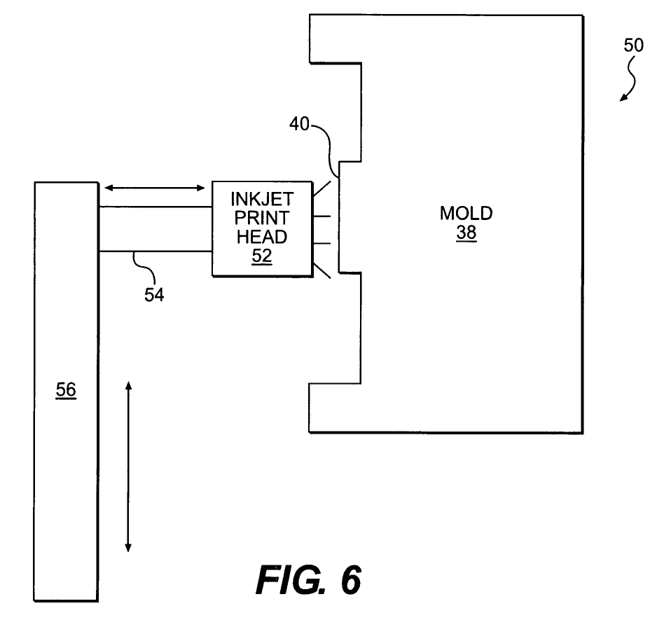

In the embodiment that is schematically depicted in FIG. 6, a mold assembly 50 includes an ink transfer system that is constructed and arranged to transfer an ink decoration to the mold surface portion 40 using a programmable printhead assembly 52 that is positioned with respect to the mold surface portion 40 by a drive mechanism 54 and that is controlled by a programmable controller 56.

The printhead assembly 52 is preferably a pixel-based or pixel-capable printhead such as an ink jet printhead, although it could alternatively be constructed as anyone of a number of possible alternative types of print heads that are known in the printing industry. The programmable controller 56 permits the content of the pattern of the ink decoration that is applied to the mold surface portion 40 to be modified between or during a mold cycle. The modification could be to change the content of the decoration between mold cycles, or to modulate the amount of an ink that is applied to the mold surface portion 40 for manufacturing quality control purposes in order to optimize the deposition of ink to the mold surface portion 40.

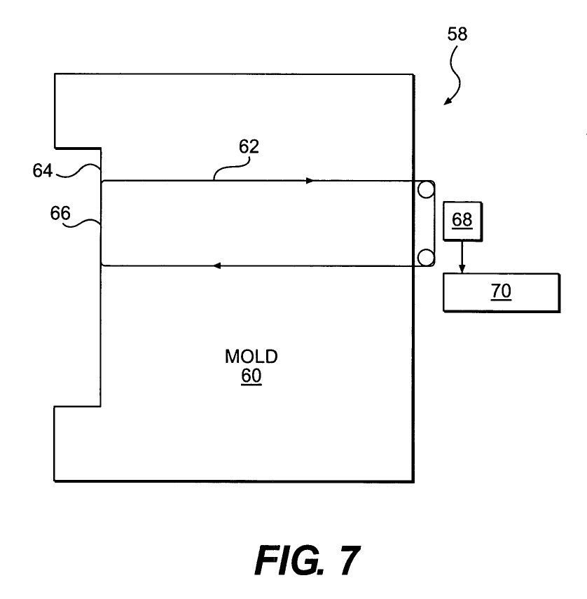

In the embodiment that is schematically depicted in FIG. 7, a mold assembly 58 includes a mold 60 that is adapted to receive a continuously looped print ribbon 62. Print ribbon 62 is adapted to travel along a path that includes a transfer area 66 that is contiguous with and forms a part of an internal mold surface 64. An ink decoration pattern is applied to one surface of the print ribbon 62 by a printhead 68 or an alternative deposition mechanism responsive to instructions from a controller 70 that is preferably programmable. The ribbon 62 may be fabricated so that a complex pattern is preprinted thereon that is activated for transfer by the printhead 68, which in this case might be a simple heating element. Alternatively, the ribbon 62 may have a single color dye that is activated for transfer in a selected pattern by a programmable printhead 68.

The print ribbon is advanced or indexed in order to properly position the ink decoration pattern within the transfer area 66. The same surface of the print ribbon 62 becomes pressed at the transfer area 66 against a portion of an external surface of a molded article during molding using the mold 60. The print ribbon 62 is then advanced by a predetermined amount between mold cycles in order to properly position another ink decoration pattern within the transfer area 66.

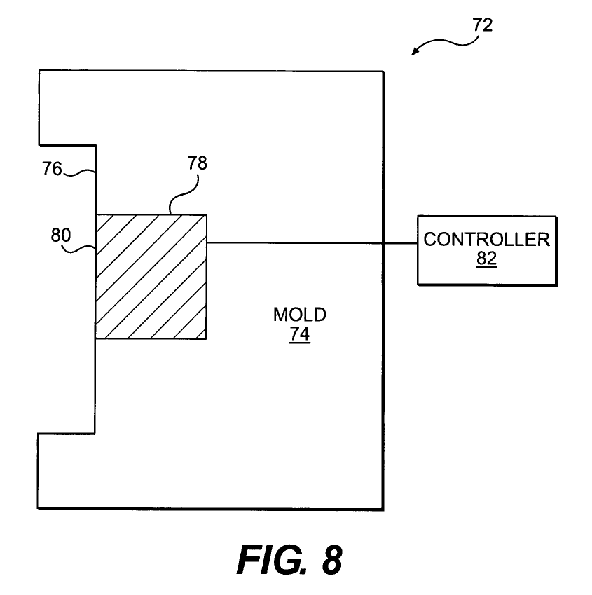

In the embodiment of the invention that is schematically depicted in FIG. 8, a mold assembly 72 includes a mold 74 having an internal molding surface 76 and an integrated printhead 80 that forms a portion of the internal molding surface 76. The integrated printhead 80 is controlled by a programmable controller 82 in order to control the content and amount of an ink decoration that is applied to an article that is molded by the mold 74. The integrated printhead 80 is preferably an ink jet type printhead although it could alternatively be constructed as anyone of a number of possible alternative types of print heads that are known in the printing industry.

A method according to a preferred embodiment includes a first step of extruding a molten plastic parison from a plastic material such as polyolefin using an extrusion die of the type that is described above. At least a portion of the molten plastic parison is surface treated in order to adjust the surface energy, such as by using any one of the three techniques that are discussed above. A plastic article such as a container is subsequently formed within a mold assembly. Preferably, a first decoration is printed on at least a portion of the container while the container is still positioned within the mold assembly. The container is then ejected from the mold assembly.

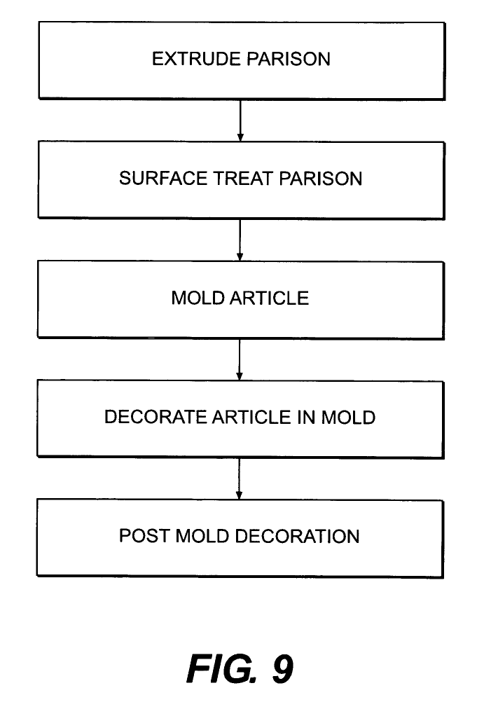

In one embodiment that is schematically depicted in FIG. 9, the container is then subjected to a post-mold decoration step wherein a supplemental decoration is applied to at least a selected portion of the external surface of the container. It is anticipated that the first decoration that is applied while the container is still in the mold could be applied selectively to this portions of the container that would be difficult to access and a postmold decoration process, while the remaining portions of the container that are intended to be decorated could be so decorated using the supplemental postmold decoration process.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for forming a molded object out of a plastic material, comprising:
an extrusion die assembly for forming an extruded plastic parison;
a mold assembly for forming a portion of the extruded plastic parison into a molded article; and
a surface treatment assembly for changing the surface energy of at least a portion of the extruded plastic parison, said surface treatment assembly being interposed between said extrusion die assembly and said mold assembly.

2. A system for forming a molded object out of a plastic material according to claim 1, wherein said surface treatment assembly is constructed and arranged to apply a plasma treatment to at least a portion of the extruded plastic parison.

3. A system for forming a molded object out of a plastic material according to claim 1, wherein said surface treatment assembly is constructed and arranged to apply a corona treatment to at least a portion of the extruded plastic parison.

4. A system for forming a molded object out of a plastic material according to claim 1, wherein said surface treatment assembly is constructed and arranged to apply a flame treatment to at least a portion of the extruded plastic parison.

5. A system for forming a molded object out of a plastic material according to claim 1, wherein said surface treatment assembly is constructed and arranged to increase the surface energy of at least a portion of the extruded plastic parison.

6. A system for forming a molded object out of a plastic material according to claim 1, wherein said surface treatment assembly is constructed and arranged to change the surface energy of a selected portion of the extruded plastic parison, and wherein said system for forming a molded object out of a plastic material further is constructed and arranged to ensure registration of said selected portion of the extruded plastic parison with a select portion of said mold assembly.

7. A system for forming a molded object out of a plastic material according to claim 1, further comprising printing means for applying a decoration to the molded article while the molded article is still within said mold assembly.

8. A system for forming a molded object out of a plastic material according to claim 1, wherein said surface treatment assembly is constructed and arranged to treat an outer surface of the extruded plastic parison to a greater extent than it treats an inner surface of the extruded plastic parison.

9. A system for forming a molded object out of a plastic material, comprising:
a surface treatment assembly for changing the surface energy of at least a portion of a molten plastic object while the plastic object is in a molten state; and
a mold assembly for forming a portion of the molten plastic object into a molded article.

10. A system for forming a molded object out of a plastic material according to claim 9, wherein said surface treatment assembly is constructed and arranged to apply a plasma treatment to at least a portion of the molten plastic object.

11. A system for forming a molded object out of a plastic material according to claim 9, wherein said surface treatment assembly is constructed and arranged to apply a corona treatment to at least a portion of the molten plastic object.

12. A system for forming a molded object out of a plastic material according to claim 9, wherein said surface treatment assembly is constructed and arranged to apply a flame treatment to at least a portion of the molten plastic object.

13. A system for forming a molded object out of a plastic material according to claim 9, wherein said surface treatment assembly is constructed and arranged to increase the surface energy of at least a portion of the molten plastic object.

14. A system for forming a molded object out of a plastic material according to claim 9, wherein said surface treatment assembly is constructed and arranged to change the surface energy of a selected portion of the molten plastic object, and wherein said system for forming a molded object out of a plastic material further is constructed and arranged to ensure registration of said selected portion of the molten plastic object with a select portion of said mold assembly.

15. A system for forming a molded object out of a plastic material according to claim 9, further comprising printing means for applying a decoration to the molded article while the molded article is still within said mold assembly.

16. A system for forming a molded object out of a plastic material according to claim 15, wherein said surface treatment assembly is constructed and arranged to treat an outer surface of the molten plastic object to a greater extent than it treats an inner surface of the molten plastic object.

17. A method of forming a molded object out of a plastic material, comprising steps of:
providing a molten plastic object;
changing the surface energy of at least a portion of the molten plastic object while it is in a molten state; and
molding at least a portion of the molten plastic object into a molded article.

18. A method of forming a molded object out of a plastic material according to claim 17, wherein said step of changing the surface energy of at least a portion of the molten plastic object while it is in a molten state comprises applying a plasma treatment to at least a portion of the molten plastic object.

19. A method of forming a molded object out of a plastic material according to claim 17, wherein said step of changing the surface energy of at least a portion of the molten plastic object while it is in a molten state comprises applying a corona treatment to at least a portion of the molten plastic object.

20. A method of forming a molded object out of a plastic material according to claim 17, wherein said step of changing the surface energy of at least a portion of the molten plastic object while it is in a molten state comprises applying a flame treatment to at least a portion of the molten plastic object.

21. A method of forming a molded object out of a plastic material according to claim 17, wherein said step of providing a molten plastic object comprises forming the molten plastic object using an extrusion die assembly.

22. A method of forming a molded object out of a plastic material according to claim 17, wherein said step of changing the surface energy of at least a portion of the molten plastic object while it is in a molten state comprises changing the surface energy of a limited selected portion of the molten plastic object, and wherein said method further comprises a step of registering the limited selected portion of the molten plastic object with a selected portion of a molding assembly.

23. A method of forming a molded object out of a plastic material according to claim 17, further comprising a step of printing a decoration on the molded plastic article.

24. A method of forming a molded object out of a plastic material according to claim 23, wherein said step of printing a decoration on the molded plastic article comprises printing the decoration on the molded plastic article when the molded plastic article is still in a molding assembly.

25. A method of forming a molded object out of a plastic material according to claim 17, wherein said step of changing the surface energy of at least a portion of the molten plastic object while it is in a molten state comprises treating an outer surface of the molten plastic object to a greater extent than an inner surface of the molten plastic object is treated.
